(19) United States
(12) Patent Application Publication
(10) Pub. No.: US 2007/0175382 A1
(43) Pub. Date: Aug. 2, 2007

(54) Temperature-sensitive mat

(76) Inventor: Lorraine Marie Warner, Valatie, NY (US)

Correspondence Address: WEST & ASSOCIATES, A PC, 2815 MITCHELL DRIVE, SUITE 209, WALNUT CREEK, CA, 94598, US

(21) Appl. No.: 11/346,721

(22) Filed: Feb. 2, 2006

(51) Int. Cl. G01K 1/02

(52) U.S. Cl. 116/216

(57) ABSTRACT

The present disclosure provides a bathmat that changes color as the temperature of water it is immersed in varies. In one embodiment of the present disclosure, the mat is designed with dimensions to fit most standard kitchen sinks, and is suitable for use when bathing a baby there. This size is, of course, suitable for use in a larger bath tub as well. The mat is constructed of, or has a layer of, thermochromatic material that can display, through a change of color, the temperature of the water.

### BACKGROUND

1. Field of the Invention

The present disclosure is for a bath mat that can sense and indicate the temperature of bath water, so that a caretaker can be assured that the temperature is kept at an optimal and safe level at all times.

2. Background

It's often a daunting task for a new parent to wash their baby for the first few weeks, months and/or years as the baby is so small and can be wriggly. It is natural for caregivers to feel scared they'll do something wrong. One important bit of knowledge that has to come from personal experience is how to get the temperature of the bath water exactly right for the baby.

A common mistake new parents make is that the bath water temperature should be tested with the wrist or elbow, and not with the hand. The hand can withstand relatively high temperatures so it's misleading. The rule-of-thumb is that bathwater should feel comfortably warm, but not hot, to the inside of the wrist or elbow. However, it is often awkward and cumbersome to lower the elbow into the water when the sink or a deeper bathtub is used, not to mention that the caretaker has to hold onto the baby. Further, what feels “comfortably warm” may be different to different people, and what feels “comfortably warm” to some adults (who are used to taking very hot baths or showers) may be scalding hot for a baby's tender skin.

Using a thermometer to constantly monitor the temperature of the bathwater would be quite cumbersome. What is desired is an apparatus that can accurately and quickly provide information about the temperature of bath water through visual indicia. A convenient way to do this would be to incorporate a temperature sensor and display into a bath mat that would be immersed in the bath water. U.S. Pat. No. 5,375,271 to Kel-Gar inc. of Dallas, Tex. teaches a bath mat that has a small heat sensitive bubble that displays a written warning when the bath water is too hot. However, the small indicators can be very hard to read when a baby is sitting on the bath mat. Similarly, Summer Infant Inc. of Lincoln, R.I. markets the Mother's Touch™ Infant Bath Tub that has a strip of color changing material that changes color when the bath water is too hot. However, the strip can also easily be obscured by the baby sitting in the bath tub.

Thermochromism is the color change phenomenon that occurs by changing the temperature of certain substances. Thermochromatic materials are used in a variety of commercial products including textiles, novelty items, toys, and baby spoons. Most thermochromatic commercial products are derived from liquid crystals or a mixture of organic dyes. Both of these methods require the materials to be microencapsulated.

Thermochromatic materials are disclosed in U.S. Pat. No. 4,567,019 issued to Lawton on Jan. 28, 1986; U.S. Pat. No. 4,421,560 issued to Kito et al. on Dec. 20, 1983; and U.S. Pat. No. 4,028,118 issued to Nakasuji et al. on Jun. 7, 1977. Heat-sensitive recording materials are described in U.S. Pat. No. 4,611,072 issued to Nachbar et al.; U.S. Pat. No. 4,462,616 issued to Shanton on Jul. 31, 1984; and U.S. Pat. No. 4,444,819 issued to Maruta et al. A reversible heat sensitive recording composition is disclosed in U.S. Pat. No. 4,720,301 issued to Kito et al. on Jan. 19, 1988.

Therefore, it is desired to have a device that can provide a quick visual aid to a caretaker giving a bath to a baby, to ensure the temperature is kept at a safe and comfortable level throughout the bath. The visual aid should be easily viewed with just the caretaker's peripheral vision, without the need to read written warnings or to check a particular spot for the temperature indicator.

### SUMMARY OF THE INVENTION

The present disclosure provides a bath mat that changes color as the temperature of water it is immersed in varies. In one embodiment of the present disclosure, the mat is designed with dimensions to fit most standard kitchen sinks, and is suitable for use when bathing a baby there. This size is, of course, suitable for use in a larger bathtub as well. The mat is constructed of, or has a layer of, thermochromatic material that can display, through a change of color, the temperature of the water.

### BRIEF DESCRIPTION OF THE DRAWINGS

FIG. 1 depicts a planar view of the bathmat according to one embodiment.

### DETAILED DESCRIPTION

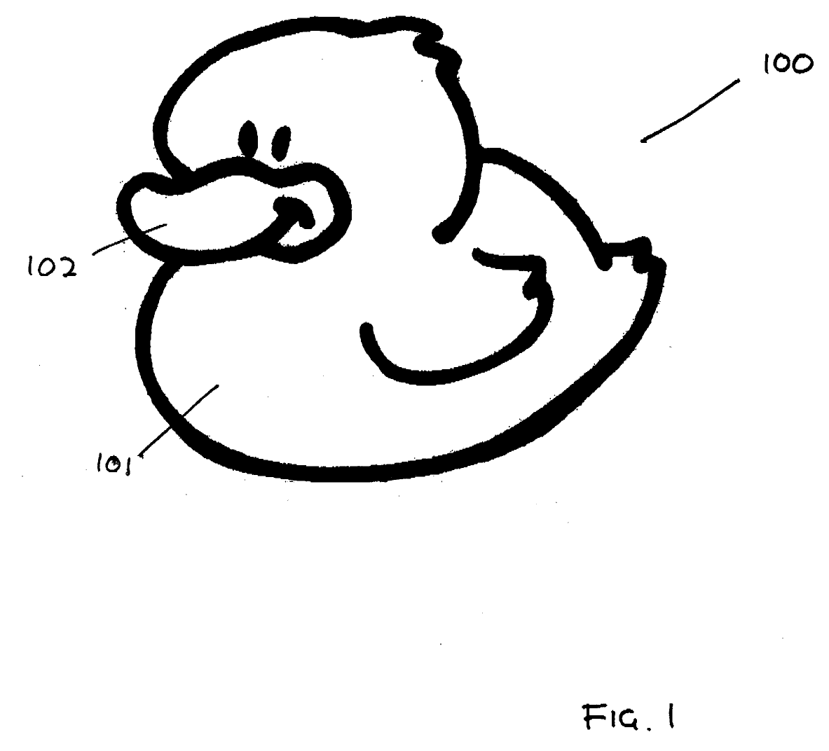

FIG. 1 depicts an embodiment of a temperature-sensing bathmat that can sense and display, in real time, the temperature of the bathwater it is immersed in. In one embodiment, the bathmat can be comprised of a thermoplastic elastomer (TPE) combined with a thermochromatic concentrate, such that the surrounding temperature of the bathmat can be visually indicated by a color change and/or color changes. That is, the bathmat can comprise a thermochromatic concentrate in a Thermoplastic Elastomer (TPE) resin that can react to changes in temperature and change color accordingly. In some embodiments the thermochromatic concentrate/TPE resin can be surrounded by an exterior barrier. In alternate embodiments, a thermochromatically responsive material can be coupled with a second material and the thermochromatically responsive material can respond to surrounding temperature changes.

By using three primary colors, any color can be adjusted. Different colors of thermochromatic pigments with the same temperature characteristics can be mixed to create more colors. Thermochromatic colors can also be mixed with regular pigments so that the color can be changed from one to another. At lower temperature, the color shown matches a first shade. When the temperature is increased, the thermochromatic pigments start fading to colorless, revealing the color of the regular pigments and thereby showing a second shade of color. Further, by mixing the thermochromatic pigments with different temperature ranges, the color can be varied for more than two colors.

In an embodiment of the bathmat, the mat is made of Thermoplastic elastomer (TPE) with the thermochromatic pigments added as an additive. Referring to FIG. 1, bathmat 100 is created in the shape of a cartoon figure, in this case a duck. The shape can be arbitrarily chosen to be aesthetically pleasing and of any convenient size and/or shape that would fit the sink or bathtub where the bathmat is intended to be used.

In some embodiments, the bathmat can show a first color and/or color scheme at room temperature. The first color and/or color scheme can be any known and/or convenient color or colors which can be created from any combination of any known and/or convenient combination of TPE and thermochromatic concentrates and/or inks.

In some embodiments, when the bathmat is immersed in a substance that is below a prescribed temperature range, the color and/or color scheme of the bathmat and/or any portion thereof, can change to a second color and/or color scheme. In some embodiments, the color and/or color scheme can be selected such that a caregiver immediately understands that the surrounding substance is cold, such as blue or green. In some embodiments, the intensity of the color and/or color scheme can be indicative of the variance of the temperature of the surrounding substance and the prescribed temperature range. However, in alternate embodiments, the bathmat may not exhibit a color change when the surrounding temperature is below a prescribed temperature range. In some embodiments the prescribed temperature range can be 90° to 100° F. However, in alternate embodiments, any convenient temperature range can be selected which can depend on the purpose/use of the mat. In some embodiments, the mat can be used by elderly people to determine temperature to prevent scalding and/or discomfort by exposure to excessively hot or cold temperatures, using one temperature range and optimal. In some embodiments, the mat can be used by pet owners to determine temperature to prevent scalding or discomfort of an animal by exposure to excessively hot or cold temperatures, using a different temperature range as optimal. Colors and/or color schemes for any prescribed temperature and/or temperature ranges can be selected based on any single or any known and/or convenient combination of any thermochromatic materials.

In some embodiments, when the bathmat is immersed in a substance that is within a prescribed temperature range, the color and/or color scheme of the bathmat can change to a third color scheme. In some embodiments the third color and/or color scheme can be visually pleasing, such as orange or yellow. In some embodiments, the intensity of the color and/or color scheme can be indicative of the variance of the temperature of the surrounding substance and the prescribed temperature range. In alternate embodiments, the bathmat may not exhibit a change in color and/or color scheme when the temperature of the surrounding substance is within the prescribed temperature range.

In some embodiments, when the temperature of the substance surrounding the bathmat is above a prescribed temperature range, the bathmat may exhibit a fourth color and/or color scheme. In some embodiments, the fourth color and/or color scheme can be a shade or shades of red. In some embodiments, the intensity of the color and/or color scheme can be indicative of the variance of the temperature of the surrounding substance and the prescribed temperature range.

In alternate embodiments, the different colors and/or color schemes and/or absence of color can be used in different regions of the bathmat. In any embodiment, the color and/or color scheme can be the absence of color, and can be transparent or opaque. By way of non-limiting example referring to the embodiment depicted in FIG. 1, the body 101 of the duck can exhibit one set of temperature indicative colors and/or color schemes and the duck bill 102 can exhibit a second set of temperature indicative colors and/or color schemes.

By way of non-limiting example, H.W. Sands Corp. of Jupiter, Fla. markets thermochromatic pigments that are suitable for application with the bathmat disclosed herein. The pigments are composed of microcapsules of particle size between 6-8 microns that can change colors reversibly in reaction to temperature changes. When temperature rises to a specified temperature, the color of the pigment can change by fading to colorless. The pigment fades back to the original color as it is cooled down. The specific temperature of the color changes can be assigned at temperatures between 15° C. to 65° C. The sensitivity of color changes is within 2° C. to 10° C. The temperature of the color change set under 33° C. has a fine sensitivity and those over 33° C. are coarser.

In a further embodiment of the invention, the design of the bathmat (for example, the cartoon figure depicted in FIG. 1) can be printed in thermochromatic ink or inks on paper or any other material convenient or known, and then laminated or sealed with a soft, transparent layer. The material for the soft layer can be chosen from any plastics or polymers known or convenient, as long as it does not obscure the color of the design underneath. Another important consideration is that if the soft layer exhibits any insulation characteristics that would insulate the thermochromatic ink from sensing the correct temperature, this must be taken into account in choosing the ink to compensate for the insulation and accurately represent the temperature of the water the bathmat is immersed in. In the above-described embodiment, the thermochromatic ink or inks could exhibit similar color changes as described above with regards to FIG. 1.

As a non-limiting example, Temp-Tell® Thermochromatic Inks, available from International Ink, LLC of Gainesville, Ga., can be used to print the design. Temp-Tell® Thermochromatic Inks can be applied to almost any type of substrate, including paper, polyester, vinyl chloride sheets and plastics, and can be used in flexographic, rotogravure and silkscreen printing processes. When used in combination with non-thermochromatic ink, any color combination can be achieved. The range of colors is fairly broad, as is the temperature at which the color changes takes place. Temp-Tell® Thermochromatic Inks are available in 14 different temperature ranges varying from 25° C. (−13° F.) to 60° C. (127.4° F.) for full color to 15° C. (5° F.) to 65° C. (149.0° F.) for no color. Similar to the discussion above with the use of Thermochromatic pigments additives, the colors shown by the ink can be chosen to represent temperature ranges that are too cold, just right, and too hot for bathing a baby.

In some embodiments, the bathmat can be formed of pliable TPE. In some embodiments, the TPE can be in the 10 Shore A to 50 Shore D durometer (hardness) range. However, in alternate embodiments, the bathmat can be formed of any known and/or convenient material having any hardness and pliability properties which can be combined and/or coupled with any known and/or convenient thermochromatic material.

Although the invention has been described in conjunction with specific embodiments thereof, it is evident that many alternatives, modifications and variations will be apparent to those skilled in the art. By way of example, a larger sized bathmat suitable for use in a bathtub, with a similar construction to the bathmat disclosed above can be made. Accordingly, the invention as described and hereinafter claimed is intended to embrace all such alternatives, modifications and variations that fall within the spirit and broad scope of the appended claims.

What is claimed is:

1. An apparatus for indicating whether a surrounding substance is within a predetermined temperature range, comprising:
a substrate; and
at least one thermochromatic substance coupled with said substrate;
wherein when a temperature proximate to said at least one thermochromatic substance is below a first prescribed temperature, said at least one thermochromatic substance provides a first visual indicator; and
wherein when a temperature proximate to said at least one thermochromatic substance is above said first prescribed temperature, said at least one thermochromatic substance provides a second visual indicator.

2. The apparatus of claim 1, wherein when a temperature proximate to said at least one thermochromatic substance is above a second prescribed temperature, said at least one thermochromatic substance provides a third visual indicator.

3. The apparatus of claim 1 wherein said at least one thermochromatic substance includes a first thermochromatic substance coupled with said substrate and a second thermochromatic substance coupled with at least one of said substrate and said first thermochromatic substance.

4. The apparatus of claim 3, wherein when a temperature proximate to said first thermochromatic substance is below a first prescribed temperature, said first thermochromatic substance provides said first visual indicator.

5. The apparatus of claim 4, wherein when a temperature proximate to said substrate is between said first prescribed temperature and said second prescribed temperature, said substrate is one of a prescribed color, transparent and opaque.

6. The apparatus of claim 4, further comprising:
a third thermochromatic substance coupled with said substrate;
wherein when a temperature proximate to said substrate is between said first prescribed temperature and said second prescribed temperature, said substrate provides a third visual indicator.

7. The apparatus of claim 4, wherein when a temperature proximate to said second thermochromatic substance is above said second prescribed temperature, said second thermochromatic substance provides said second visual indicator.

8. An apparatus for determining whether the temperature of bath water is within a selected safe temperature range, comprising:
a bath mat comprising an inner sheet encased in a soft, clear material;
said inner sheet having a design printed with at least one layer of temperature sensitive ink applied, said temperature sensitive ink being transparent above said selected safe temperature range and at least partially opaque below said selected safe temperature range;
wherein said design depicts one color below said selected safe temperature range, depicts a second color within said selected safe temperature range, and depicts a third color above said selected safe temperature range.
